(19) United States
(12) Patent Application Publication
(10) Pub. No.: US 2025/0384888 A1
(43) Pub. Date: Dec. 18, 2025

(54) METHOD AND SYSTEM FOR EXTRACTING DURATION OF SINGING VOICE PHONEME USING MIDI

(71) Applicant: Korea Electronics Technology Institute, Seongnam-si (KR)

(72) Inventors: Tae Woo KIM, Seongnam-si (KR); Choong Sang CHO, Seongnam-si (KR); Young Han LEE, Seongnam-si (KR)

(73) Assignee: Korea Electronics Technology Institute, Seongnam-si (KR)

(21) Appl. No.: 18/933,437

(22) Filed: Oct. 31, 2024

(30) Foreign Application Priority Data
Jun. 14, 2024 (KR) 10-2024-0077449

(51) Int. Cl. G10L 19/00; G10L 25/03

(52) U.S. Cl. CPC G10L 19/0018; G10L 25/03

(57) ABSTRACT

There are provided a method and a system for extracting singing voice phoneme duration. A singing voice phoneme duration extraction system using a MIDI according to an embodiment may receive phonemes converted from a text as input, and may output a prior probability distribution, may receive acoustic features as input and may output a posterior probability distribution, may convert the probability distribution, may perform monotonic alignment search by using information on MIDI duration, and may output a waveform which is a voice digital signal, based on input reflecting a result of extracting the phoneme duration.

### CROSS-REFERENCE TO RELATED APPLICATION(S) AND CLAIM OF PRIORITY

This application is based on and claims priority under 35 U.S.C. § 119 to Korean Patent Application No. 10-2024-0077449, filed on Jun. 14, 2024, in the Korean Intellectual Property Office, the disclosure of which is herein incorporated by reference in its entirety.

### BACKGROUND

### Field

The disclosure relates to a method and a system for extracting duration of singing voice phonemes, and more particularly, to a method and a system for extracting duration of singing voice phonemes by using a musical instrument digital interface (MIDI).

### Description of Related Art

Phoneme duration information of a voice is essential for training a text-to-speech (TTS) model.

The structure of the text-to-speech model may be divided into an autoregressive method and a non-autoregressive method. Autoregressive voice synthesis is a method for predicting a next voice frame through a previous voice frame, and may implicitly predict phoneme duration in a training process.

On the other hand, non-autoregressive voice synthesis predicts voice features based on input of a given text at a time, and hence, should know the number of frames (phoneme durations) of phenome expressions converted from the text.

Accordingly, the phoneme duration may be predicted through a phoneme duration predictor, and accordingly, encoded phoneme expressions are extended to the same length as the voice features, and are transmitted to a decoder. Here, implicit phoneme duration information is needed to train the phoneme duration predictor.

In a related-art method of acquiring phoneme duration information for training a non-autoregressive text-to-speech model, phoneme duration may be acquired by using a Montoreal Forced Aligner (MFA).

With the recent development of voice synthesis, singing voice synthesis (SVS) technologies are also developing with the structure of the text-to-speech model.

Such SVS refers to a technology that receives a music score consisting of lyrics (text) and a MIDI, and creates a singing voice. Accordingly, lyrics may be created according to lengths of MIDI notes and pitch of notes as indicated in the score.

Like TTS, SVS may require phoneme duration to train a non-autoregressive synthesis model, but a singing voice may include complex singing characteristics such as sound of breathing, banding, vibrato, which is different from a normal voice, and hence, it may be difficult to extract accurate phoneme duration even with MFA or variational interference with adversarial learning for text-to-speech (VITS) (end-to-end voice synthesis system).

Accordingly, human annotators should obtain inter-phoneme boundaries by annotating, and thus, there is a problem that it takes much time and much money.

### SUMMARY

The disclosure has been developed in order to solve the above-described problems, and an object of the disclosure is to provide a method and a system for extracting enhanced phoneme duration of a singing voice by using MIDI information in an end-to-end singing voice synthesis model to which MIDI information is additionally inputted.

According to an embodiment of the disclosure to achieve the above-described object, there is provided a singing voice phoneme duration extraction system using a MIDI, including: a prior encoder configured to receive phonemes converted from a text as input, and to output a prior probability distribution; a posterior encoder configured to receive acoustic features as input and to output a posterior probability distribution; a flow configured to convert the probability distribution to simplify the posterior probability distribution; a monotonic alignment search module configured to perform monotonic alignment search by using information on MIDI duration to extract phoneme duration; and a decoder configured to output a waveform which is a voice digital signal, based on input reflecting a result of extracting the phoneme duration.

The prior encoder may additionally receive MIDI pitch and MIDI duration, as input, in addition to phonemes converted from lyrics which is a text, to perform monotonic alignment search by using the MIDI duration information.

In addition, information inputted to the prior encoder may be information in which a text, pitch, and duration of the MIDI corresponding to each phoneme are mapped.

The monotonic alignment search module may divide phoneme sections by using the MIDI duration information, and then may perform monotonic alignment search for each phoneme section.

The monotonic alignment search module may perform monotonic alignment search between the posterior probability distribution and the prior probability distribution in every phoneme section.

The monotonic alignment search module may divide the respective phoneme sections, and may independently extract phoneme duration for all phonemes.

The prior encoder may include a text encoder and a projection layer.

The acoustic features may be a linear spectrogram or a Mel-spectrogram.

The decoder may receive the posterior probability distribution as input when learning, and may output a waveform which is a voice digital signal, and may receive the prior probability distribution undergoing inverse transformation on the probability distribution as input when inferring, and may output a waveform which is a voice digital signal.

According to another embodiment of the disclosure, there is provided a singing voice phoneme duration extraction method using a MIDI, including: receiving, by a prior encoder, phonemes converted from a text as input, and outputting a prior probability distribution; receiving, by a posterior encoder, acoustic features as input and outputting a posterior probability distribution; converting, by a flow, the probability distribution to simplify the posterior probability distribution; performing, by a monotonic alignment search module, monotonic alignment search by using information on MIDI duration; extracting, by the monotonic alignment search module, phoneme duration through a result of the monotonic alignment search; and outputting, by a decoder, a waveform which is a voice digital signal, based on input reflecting a result of extracting the phoneme duration.

According to still another embodiment of the disclosure, there is provided a singing voice phoneme duration extraction system using a MIDI, including: a prior encoder configured to receive phonemes converted from a text, MIDI pitch, and MIDI duration as input, and to output a prior probability distribution; a posterior encoder configured to receive acoustic features as input and to output a posterior probability distribution; a flow configured to convert the probability distribution to simplify the posterior probability distribution; and a monotonic alignment search module configured to perform monotonic alignment search by using information on MIDI duration to extract phoneme duration.

As described above, according to embodiments of the disclosure, the problem of cost and time arising in a related-art method in which an annotator directly annotates to acquire phonemes of a singing voice may be solved, and phoneme duration information for training a non-autoregressive singing voice synthesis model may be provided more accurately and efficiently.

In addition, inaccurate alignment caused by complicated characteristics of a singing voice, such as sound of breathing, banding, vibrato, may be prevented by limiting phoneme sections.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view provided to explain a system for extracting phoneme duration of a singing voice by using a MIDI according to an embodiment of the disclosure;

FIG. 2 is a view illustrating input expressions of the singing voice phoneme duration extraction system using the MIDI according to an embodiment of the disclosure;

FIG. 3 is a view provided to explain a related-art monotonic alignment search method;

FIG. 4 is a view provided to explain a monotonic alignment search method of a singing voice phoneme duration extraction system using a MIDI according to an embodiment of the disclosure; and

FIG. 5 is a view provided to explain a singing voice phoneme duration extraction method using a MIDI according to an embodiment of the disclosure.

### DETAILED DESCRIPTION

Hereinafter, the disclosure will be described in more detail with reference to the accompanying drawings.

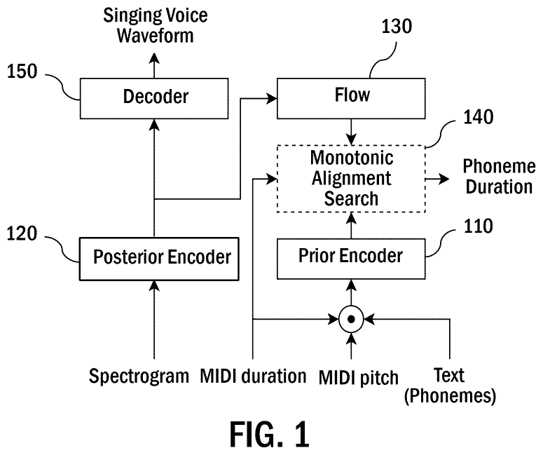

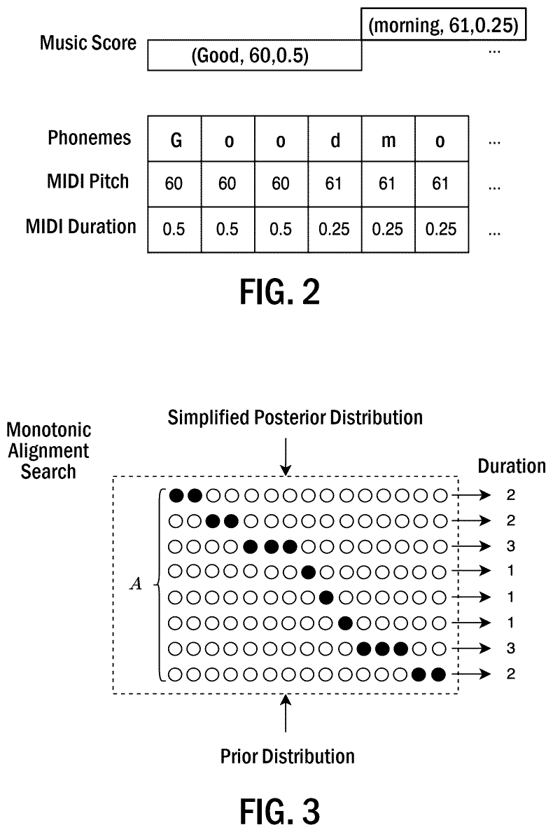

FIG. 1 is a view provided to explain a singing voice phoneme duration extraction system using a MIDI according to an embodiment of the disclosure, and FIG. 2 is a view illustrating input expressions of the singing voice phoneme duration extraction system using the MIDI according to an embodiment of the disclosure.

The singing voice phoneme duration extraction system using the MIDI (hereinafter, referred to as an “extraction system”) according to the present embodiment is provided to extract enhanced phoneme duration of a singing voice by using MIDI information in an end-to-end singing voice synthesis model to which MIDI information is additionally inputted.

To achieve this, the extraction system may include a prior encoder 110, a posterior encoder 120, a flow 130, a monotonic alignment search module 140, and a decoder 150.

The prior encoder 110 is provided to receive phonemes which are converted from a text (for example, lyrics) and to output a prior probability distribution.

To achieve this, the prior encoder 110 may include a text encoder and a projection layer.

The prior encoder 110 may additionally receive MIDI pitch and MIDI duration, as input, in addition to the phonemes converted from the lyrics which is the text in order to perform monotonic alignment search by using MIDI duration information.

In this case, information inputted to the prior encoder 110 may be information in which text, pitch, and duration of the MIDI corresponding to each phoneme are mapped as shown in FIG. 2.

Specifically, in a music score, every MIDI includes phonemes, pitch, and duration, and, to input these to the prior encoder 110, text (phoneme), pitch (MIDI Pitch), and duration (MIDI Duration) of the MIDI corresponding to each phoneme may be mapped as shown in FIG. 2, and then, may be inputted to the prior encoder 110.

The posterior encoder 120 is provided to receive acoustic features of a linear spectrogram or a Mel-spectrogram, and to output a posterior probability distribution.

The flow 130 may convert the probability distribution to simplify the posterior probability distribution.

The monotonic alignment search module 140 may perform monotonic alignment search by using information on MIDI duration, and may extract phoneme duration through a result of the monotonic alignment search.

Specifically, phoneme duration information may be needed to make the length of the prior probability distribution equal to the length of the posterior probability distribution. Therefore, the monotonic alignment search module 140 performs the monotonic alignment search to achieve alignment to maximize likelihood between the prior probability distribution and the posterior probability distribution.

The phoneme duration information extracted by the monotonic alignment search may be used for extending the length of the prior probability distribution to be equal to the length of the posterior probability distribution. In addition, the phoneme duration information may be used for training a target of a phoneme duration predictor.

The decoder 150 may output a waveform which is a voice digital signal based on input reflecting a result of extracting the phoneme duration.

For example, the decoder 150 may receive, as input, a result of extending the encoded phoneme expressions to the same length as acoustic features according to a result of extracting the phoneme duration, and may output a waveform which is a voice digital signal.

The decoder 150 may receive the posterior probability distribution as input when learning, and may output a waveform which is a voice digital signal, and may receive the prior probability distribution undergoing inverse transformation on the probability distribution as input when inferring, and may output a waveform which is a voice digital signal.

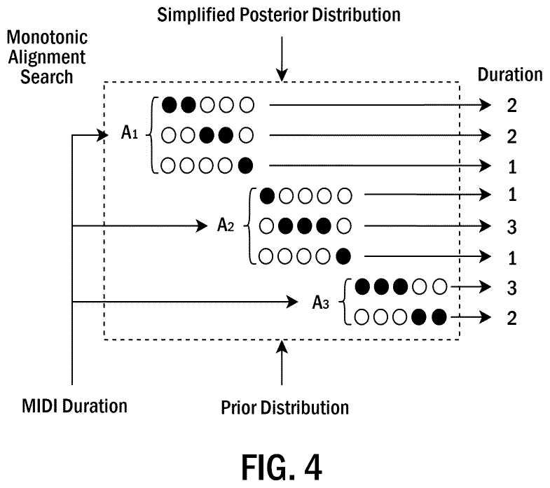

FIG. 3 is a view provided to explain a related-art monotonic alignment search method, and FIG. 4 is a view provided to explain a monotonic alignment search method of the singing voice phoneme duration extraction system using the MIDI according to an embodiment of the disclosure.

When monotonic alignment search is performed by using a VITS (end-to-end voice synthesis system) in the related-art method, search is performed on the entire sentences rather than phonemes as shown in FIG. 3, and hence, there is a problem that it is difficult to extract accurate phoneme duration due to the complicated characteristics of a long sentence or a singing voice.

On the other hand, the monotonic alignment search module 140 according to the present embodiment performs monotonic alignment search by using information on MIDI duration as described above. In this case, phoneme sections are divided and then monotonic alignment search is performed on each phoneme section, accordingly, phoneme duration may be accurately extracted in spite of the complicated characteristics of a long sentence or a singing voice.

That is, the monotonic alignment module 140 divides phoneme sections by using MIDI duration information, and then, performs monotonic alignment search on each phoneme section. Specifically, the monotonic alignment module 140 may perform monotonic alignment search between the posterior probability distribution and the prior probability distribution in every phoneme section, and may independently extract phoneme duration for all phonemes.

By doing this, the phoneme duration information may be provided more accurately and efficiently, and inaccurate alignment caused by complicated characteristics of a singing voice, such as sound of breathing, banding, vibrato, may be prevented by limiting phoneme sections.

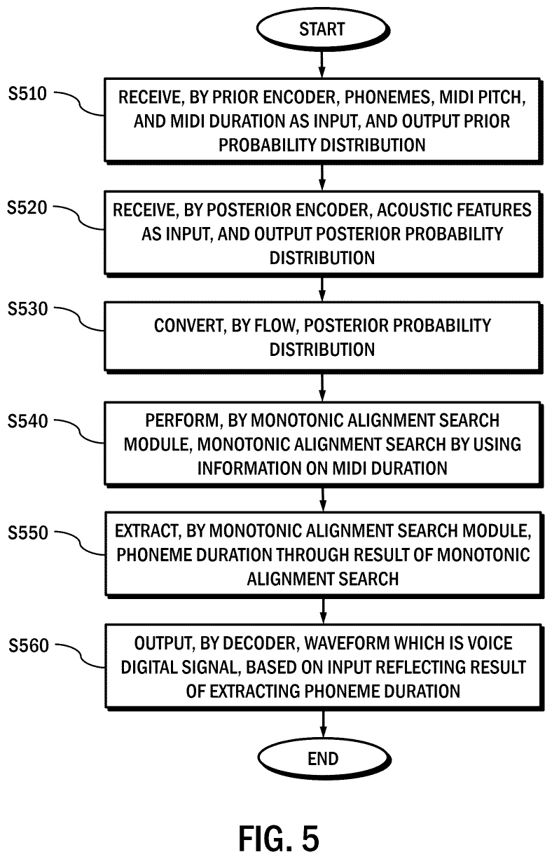

FIG. 5 is a view provided to explain a singing voice phoneme duration extraction method using a MIDI according to an embodiment of the disclosure.

The singing voice phoneme duration extraction method according to the present embodiment may be executed by the extraction system described above with reference to FIGS. 1, 2, 3, and 4.

Specifically, the prior encoder 110 may receive input of phonemes converted from a text, MICI pitch, and MIDI duration, and may output a prior probability distribution (S510).

When the posterior encoder 120 receives input of acoustic features and outputs a posterior probability distribution (S520), the flow 130 may convert the probability distribution to simplify the posterior probability distribution (S530).

When the monotonic alignment search module 140 receives the prior probability distribution, which is the output of the prior encoder 110, as input, the monotonic alignment search module 140 may additionally receive information on MIDI duration as input, and may perform monotonic alignment search by using the information on the MIDI duration (S540), and may extract phoneme duration through the result of the monotonic alignment search (S550), and may transmit the result of extracting the phoneme duration to the decoder 150.

The decoder 150 may receive a result of extending the encoded phoneme expression to the same length as acoustic features, as input, according to the result of extracting the phoneme duration, and may output a waveform which is a voice digital signal (S560).

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. A singing voice phoneme duration extraction system using a MIDI, comprising:
a prior encoder configured to receive phonemes converted from a text as input, and to output a prior probability distribution;
a posterior encoder configured to receive acoustic features as input and to output a posterior probability distribution;
a flow configured to convert the probability distribution to simplify the posterior probability distribution;
a monotonic alignment search module configured to perform monotonic alignment search by using information on MIDI duration to extract phoneme duration; and
a decoder configured to output a waveform which is a voice digital signal, based on input reflecting a result of extracting the phoneme duration.

2. The singing voice phoneme duration extraction system of claim 1, wherein the prior encoder is configured to additionally receive MIDI pitch and MIDI duration, as input, in addition to phonemes converted from lyrics which is a text, to perform monotonic alignment search by using the MIDI duration information.

3. The singing voice phoneme duration extraction system of claim 2, wherein information inputted to the prior encoder is information in which a text, pitch, and duration of the MIDI corresponding to each phoneme are mapped.

4. The singing voice phoneme duration extraction system of claim 2, wherein the monotonic alignment search module is configured to divide phoneme sections by using the MIDI duration information, and then to perform monotonic alignment search for each phoneme section.

5. The singing voice phoneme duration extraction system of claim 4, wherein the monotonic alignment search module is configured to perform monotonic alignment search between the posterior probability distribution and the prior probability distribution in every phoneme section.

6. The singing voice phoneme duration extraction system of claim 4, wherein the monotonic alignment search module is configured to divide the respective phoneme sections, and to independently extract phoneme duration for all phonemes.

7. The singing voice phoneme duration extraction system of claim 1, wherein the prior encoder comprises a text encoder and a projection layer.

8. The singing voice phoneme duration extraction system of claim 1, wherein the acoustic features are a linear spectrogram or a Mel-spectrogram.

9. The singing voice phoneme duration extraction system of claim 1, wherein the decoder is configured to receive the posterior probability distribution as input when learning, and to output a waveform which is a voice digital signal, and to receive the prior probability distribution undergoing inverse transformation on the probability distribution as input when inferring, and to output a waveform which is a voice digital signal.

10. A singing voice phoneme duration extraction method using a MIDI, comprising:
receiving, by a prior encoder, phonemes converted from a text as input, and outputting a prior probability distribution;
receiving, by a posterior encoder, acoustic features as input and outputting a posterior probability distribution;
converting, by a flow, the probability distribution to simplify the posterior probability distribution;
performing, by a monotonic alignment search module, monotonic alignment search by using information on MIDI duration;
extracting, by the monotonic alignment search module, phoneme duration through a result of the monotonic alignment search; and
outputting, by a decoder, a waveform which is a voice digital signal, based on input reflecting a result of extracting the phoneme duration.

11. A singing voice phoneme duration extraction system using a MIDI, comprising:
a prior encoder configured to receive phonemes converted from a text, MIDI pitch, and MIDI duration as input, and to output a prior probability distribution;
a posterior encoder configured to receive acoustic features as input and to output a posterior probability distribution;
a flow configured to convert the probability distribution to simplify the posterior probability distribution; and
a monotonic alignment search module configured to perform monotonic alignment search by using information on MIDI duration to extract phoneme duration.
